(19) United States
(12) Patent Application Publication
(10) Pub. No.: US 2016/0169072 A1
(43) Pub. Date: Jun. 16, 2016

(54) EXHAUST AFTERTREATMENT SYSTEM AND METHOD

(71) Applicant: BORGWARNER INC., Auburn Hills, MI (US)

(72) Inventor: David B. ROTH, Groton, NY (US)

(21) Appl. No.: 14/902,611

(22) PCT Filed: Jul. 7, 2014
(86) PCT No.: PCT/US2014/045545

§ 371 Date: Jan. 4, 2016

Related U.S. Application Data
(60) Provisional application No. 61/844,596, filed on Jul. 10, 2013.

(51) Int. Cl. F01N 3/10; F02B 25/24; F01N 3/20; F02B 27/04

(52) U.S. Cl. CPC F01N 3/105; F02B 27/04; F02B 25/24; F01N 3/20

(57) ABSTRACT

One variation may include a method of controlling exhaust gas flow in an internal combustion engine system, and products and systems using same.

### CROSS-REFERENCE TO RELATED APPLICATIONS

This application claims the benefit of the filing date of U.S. Provisional Application No. 61/844,596 filed Jul. 10, 2013.

### TECHNICAL FIELD

The field to which the disclosure generally relates includes exhaust aftertreatment systems.

### BACKGROUND

Vehicles may include an exhaust aftertreatment system.

### SUMMARY OF SELECT ILLUSTRATIVE VARIATIONS

One variation of the invention may include a method of exhaust aftertreatment for an internal combustion engine system, which includes an engine with at least one cylinder, each cylinder with divided exhaust gas flow between blowdown and scavenging exhaust valves, and at least one cylinder connected to an exhaust subsystem through a blowdown exhaust valve manifold and a scavenging exhaust valve manifold having the exhaust subsystem in fluid communication with a first catalyst, the exhaust subsystem in communication with the engine wherein the method comprises communicating exhaust gas from at the blowdown exhaust valve manifold and the scavenging exhaust valve manifold to the first catalyst; and varying the timing of the blowdown exhaust valve.

Another variation of the invention may include may include an internal combustion engine system, comprising: an internal combustion engine including a plurality of cylinders, each having a blowdown exhaust valve and a scavenging exhaust valve wherein at least one cylinder is connected to an exhaust subsystem to carry exhaust gases away from the engine; wherein the exhaust subsystem carries exhaust gases away from the engine, and including a blowdown exhaust manifold in communication with the blowdown exhaust valves of the cylinders connected to the exhaust subsystem, and a scavenging exhaust manifold in communication with the scavenging exhaust valves of the cylinders connected to the exhaust subsystem; a first catalyst connected to the exhaust subsystem; and a controller configured and arranged to adjust the timing of at least one of the scavenging exhaust valve or blowdown exhaust valve to control the air fuel mixture of the exhaust gas entering the first catalyst.

Other variations of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Variations of the invention will become more fully understood from the detailed description and the accompanying drawings, wherein:

FIG. 1A is a schematic view of an internal combustion engine system according to one variation of the invention;

FIG. 1B is a schematic view of an internal combustion engine system according to another variation of the invention;

FIG. 1C is a schematic view of an internal combustion engine system according to another variation of the invention;

FIG. 2 is a diagrammatic view of a concentric cam phaser device for use in the system of FIG. 1 according to another variation of the invention;

FIG. 3 is a flow chart of a method of controlling exhaust gas flow divided between at least one turbocharger and at least one exhaust gas recirculation path of the system of FIG. 1 according to another variation of the invention; and

FIG. 4 is a graph of HC v Scavenge Cam Retard according to one variation of the invention.

### DETAILED DESCRIPTION OF SELECT VARIATIONS

The following description of select variations of the invention is merely illustrative in nature and is in no way intended to limit the invention, its application, or uses.

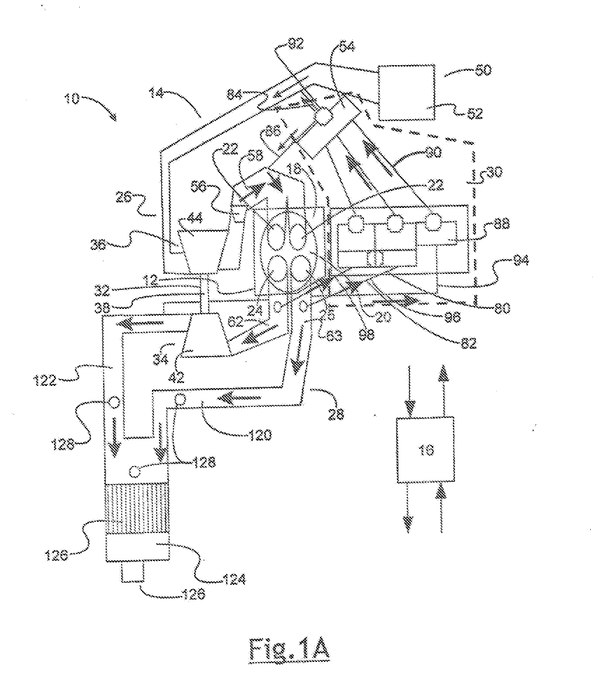

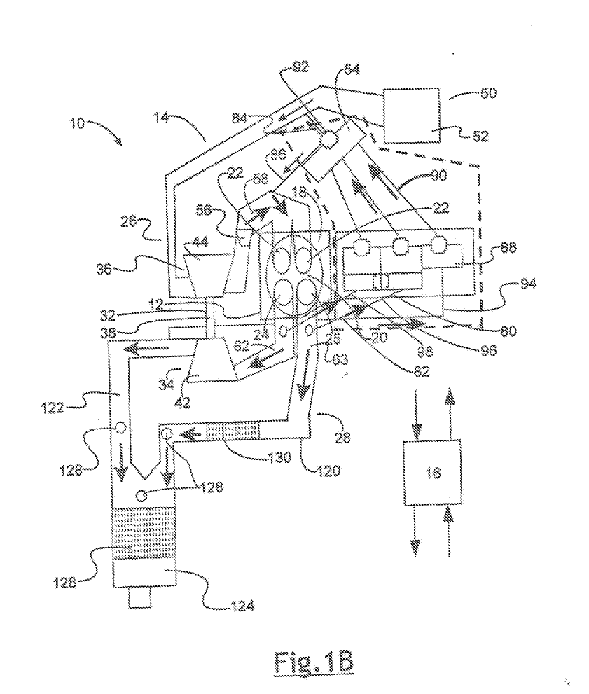

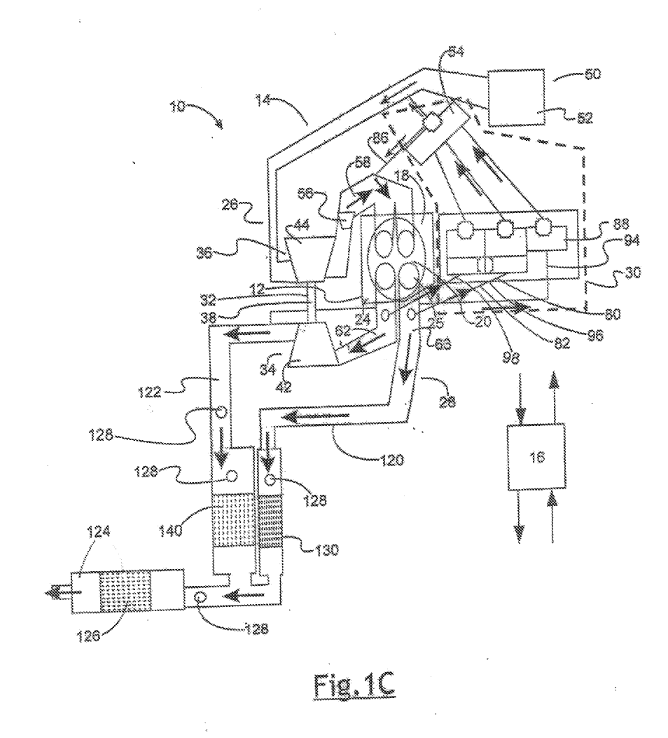

Referring to FIG. 1A-1C, one variation may include a system and a method that may be carried out using any suitable system and, more specifically, may be carried out in conjunction with an engine system such as system 10. The following system description simply provides a brief overview of one variation of an engine system, but other systems and components not shown here could also support the presently disclosed method.

In general, the system 10 may include an internal combustion engine 12 that may combust a mixture of fuel and induction gases for conversion into mechanical rotational energy and exhaust gases and an engine breathing system 14 that may deliver induction gases to the engine 12 and carry exhaust gases away from the engine 12. The system 10 may also include a fuel subsystem (not shown) to provide any suitable liquid and/or gaseous fuel to the engine 12 for combustion therein with the induction gases, and a control subsystem 16 to control operation of the engine system 10.

The internal combustion engine 12 may be any suitable type of engine, such as a spark-ignition engine like a gasoline engine, an auto-ignition or compression-ignition engine like a diesel engine, or the like. The engine 12 may include a block 18 with cylinders and pistons therein (not separately shown), which, along with a cylinder head (also not separately shown), may define combustion chambers 20 for internal combustion of a mixture of fuel and induction gases. The engine 12 may also include any suitable quantities of intake valves 22 and exhaust valves that may include any suitable number of first or blowdown exhaust valves 24 and second or scavenging exhaust valves 25. Only one cylinder is pictured in the drawings for clarity.

The engine 12 may include any quantity of cylinders, and may be of any size and may operate according to any suitable speeds and loads. Illustrative idle speeds may be on the order of about 500 to about 800 RPM, and typical maximum engine speed may be on the order of about 5500-6500 RPM but may even exceed that range. As used herein, the term low speeds and loads may include about 0% to 33% of maximum engine speeds and loads, intermediate speeds and loads may include about 25% to 75% of maximum engine speeds and loads, and high speeds and loads may include about 66% to 100% of maximum engine speeds and loads. As used herein, low to intermediate speeds and loads may include about 0% to 50% of maximum engine speeds and loads, and intermediate to high speeds and loads may include about 50% to 100% of maximum engine speeds and loads.

Valve timing may be regulated by camshafts or valve solenoids or the like to open the valves. In an illustrative example of an engine cycle, an exhaust valve opens just before a piston reaches a bottom dead center (BDC) position and soon thereafter about half of all combusted induction gases exit the combustion chambers under relatively high pressure. This may be referred to as a blowdown phase of the exhaust portion of the engine cycle. The piston sweeps back upward toward a top dead center position (TDC) and displaces most if not all of the remaining combusted induction gases out of the combustion chambers under relatively lower pressure. This may be referred to as a scavenging phase of the exhaust portion of the engine cycle.

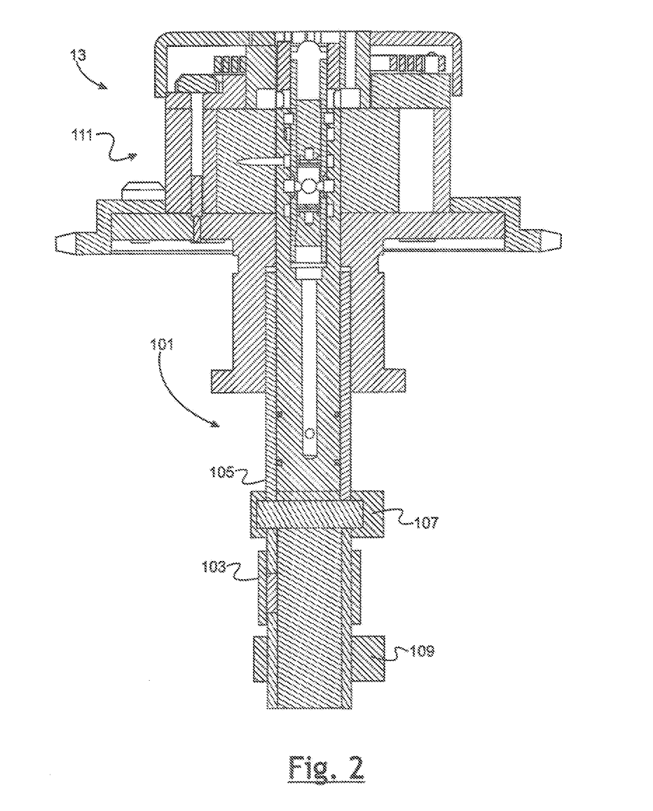

Referring now to FIG. 2, the engine 12 may include any suitable variable valve timing devices to actuate the exhaust valves 24, 25 as is known in the art. In one example, individual actuators such as solenoids (not shown) may be used to actuate the exhaust valves 24, 25. In another example, a dual acting concentric cam device 13 may be used to actuate each of the exhaust valves 24, 25 independently of the other. The device 13 may include a camshaft assembly 101 that may include concentric shafts including a cam shaft 103 carried by a cam tube 105. The cam shaft 103 carries blowdown or scavenging valve cams 107, 109 and the cam tube 105 carries the other of the blowdown or scavenging valve cams 107, 109. In one variation, the shaft or tube coupled to the blowdown valve cams may be of fixed phase relationship with respect to an engine crankshaft and another concentric shaft coupled to the scavenging valves may be of variable phase relationship with respect to the engine crankshaft varied by a cam phaser 111. In another variation, offering somewhat greater performance and efficiency, one or more cam phasers 111 may vary the phase relationship of the cam shaft 107 and tube 109 independently with respect to one another and with respect to the engine crankshaft. The timing and/or lift of the exhaust valves may be controlled by adjusting the phase or angle between the cam shaft 107 and tube 109 with the phaser(s) 111.

The cam device 13 may be controlled by the control subsystem 16, such as an engine electronic control module, based on engine testing and calibration to produce good engine emissions and efficiency at all speeds and loads. The cam device 13 may be the primary device in conjunction with the exhaust valves 24, 25 to vary energy delivered to the turbocharger turbine and thus control turbocharger boost without need for a turbo wastegate device. In another variation, various materials described herein may also be used with systems without a turbocharger. In other select variations, the methods described herein may be used with engine breathing systems including a supercharger, a precharger, a variable geometry turbocharger and/or a multi-stage turbocharger.

In general, optimal valve timing of blowdown and scavenging valves will be application specific and, thus, will vary from engine to engine. But, the blowdown valves 24 may have relatively advanced timing and may have longer valve opening duration with higher lift than the scavenging valves 25. In one example, the lift of the blowdown valves 24 may be the maximum lift attainable in approximately 180 degrees of crank angle, and the lift of the scavenging valves 25 may be the maximum lift attainable in approximately 160 degrees of crank angle.

Illustrative valve timing including duration and/or lift for the blowdown valve(s) 24 may be on the order of about 70 to 100% of valve timing for the same or similar engine equipped with conventional exhaust valves. More specific exemplary valve timing for the blowdown valve(s) 24 may be about 85-95% (e.g. 90%) duration and about 90-100% (e.g. 95%) lift of valve duration and lift timing for the same or similar engine equipped with conventional exhaust valves. Valve opening timing of the blowdown valve(s) 24 generally may be similar to or retarded at minimum turbocharger boost condition, and advanced to increase boost. Illustrative phase authority for the cam device 13 for the blowdown valve(s) 24 may be on the order of about 25 to 40 degrees (e.g. 28 degrees) of crankshaft angle between about 2000 and 5500 RPM.

Illustrative valve timing including duration and/or lift for the scavenging valve(s) 25 may be on the order of about 60 to 90% of valve timing for the same or similar engine equipped with conventional exhaust valves. More specific variations of valve timing for the scavenging valve(s) 25 may be about 75-85% (e.g. 80%) duration and about 80-90% (e.g. 85%) lift of valve duration and lift timing for the same or similar engine equipped with conventional exhaust valves. Valve closing timing of the scavenging valve(s) 25 generally may be similar to valve closing timing of the same or similar engine equipped with conventional exhaust valves. Illustrative phase authority for the cam device 13 for the scavenging valve(s) 25 may be on the order of about 30 to 60 degrees (e.g. 40 degrees) of crankshaft angle between about 2000 and 5500 RPM.

Referring to FIG. 1A, the engine breathing system 14 may include an induction subsystem 26 that may compress and cool induction gases and convey them to the engine 12 and an exhaust subsystem 28 that may extract energy from exhaust gases and carry them away from the engine 12. The engine breathing system 14 may also include an exhaust gas recirculation (EGR) subsystem 30 in communication across the exhaust and induction subsystems 26, 28 to recirculate exhaust gases for mixture with fresh air to reduce emissions and pumping losses from the engine system 10. The engine breathing system 14 may further include a turbocharging system 32 between the induction and exhaust subsystems 26, 28 to compress inlet air and thereby improve combustion to increase engine power output. As used herein, the phrase induction gases may include fresh air, compressed air, and/or recirculated exhaust gases.

One variation may include a turbocharging subsystem 32 that may be a single stage system, as shown, or may be a multi-stage or sequential turbocharging subsystem. The turbocharging subsystem 32 may include a turbine side 34 in the exhaust subsystem 28 and a compressor side 36 in the induction subsystem 26. Multi-stage turbocharging may allow for continuously variable adaptation of the turbine and compressor sides 34, 36 of the subsystem 32 over most or all engine operating points. The turbocharging subsystem 32 may include one, two, or more turbochargers of any size and type, that may be connected in series, parallel, or both, and that may or may not use wastegate valving or bypass regulation. In other words, the subsystem 32 may also include any suitable compressor and/or turbine bypass or wastegate valves of any suitable type. But it is contemplated that the method and apparatus disclosed herein will reduce or eliminate need for turbine bypass valves.

A select variation of a turbocharging subsystem 32 may include a turbocharger 38. The turbocharger 38 may be of variable turbine geometry (VTG) type of turbochargers, dual-stage turbochargers, or turbochargers with wastegate or bypass devices, or the like. Although VTG turbochargers tend to cause increased backpressure and concomitant reduced fuel economy in engines equipped with conventional exhaust systems, VTG turbochargers may be more efficient when used with a divided exhaust engine such as engine 12. This is because pumping mean effective pressure (PMEP) penalties, due to pumping parasitic losses, at small nozzle openings may be greatly reduced when turbine energy is delivered by the blowdown exhaust valve path because exhaust backpressure acting on engine pistons during exhaust are typically minimally affected by high backpressure at a turbocharger turbine inlet. In any case, the turbocharger 38 and/or any turbocharger accessory device(s) may be adjusted to affect any one or more of the following exemplary parameters: turbocharger boost pressure, air mass flow, and/or EGR flow.

In one variation the turbocharger 38 may include a turbine 42 and a compressor 44 mechanically coupled to the turbine 42.

In select variations the induction subsystem 26 may include, in addition to suitable conduit and connectors, an inlet end 50 which may have an air filter 52 to filter incoming air. The induction subsystem 26 may also include a charge air cooler 54 downstream of the turbocharger compressor 44 to cool the compressed air, and an intake throttle valve 56 downstream of the charge air cooler 54 to throttle the flow of the cooled air to the engine 12. The induction subsystem 26 also may include an intake manifold 58 downstream of the throttle valve 56 and upstream of the engine 12, to receive the throttled air and distribute it to the engine combustion chambers 20. The induction subsystem 26 may also include any other suitable devices.

In select variations the exhaust subsystem 28 may include, in addition to suitable conduit and connectors, an exhaust manifold to collect exhaust gases from the combustion chambers 20 of the engine 12 and convey them downstream to the rest of the exhaust subsystem 28. The exhaust manifold may include a blowdown exhaust manifold 62 in communication with the blowdown exhaust valves 24, and a scavenging exhaust manifold 63 in communication with the scavenging exhaust valves 25. The exhaust manifold may be separate from, or integrated with, the cylinder head (not separately shown). The blowdown and scavenging exhaust manifolds 62, 63 may be separate, or integrated with one another.

In one variation the exhaust subsystem 28 also may include one or both of the turbocharger turbine 42 in downstream communication with the exhaust manifold and, more particularly, with the blowdown manifold 62. The exhaust subsystem 28 may also include any quantity of suitable emissions devices, such as emission device(s) downstream of the exhaust manifold. The emission device(s) may include one or more catalytic converters like a close-coupled diesel oxidation catalyst (DOC) device, a nitrogen oxide (NOx) absorber unit, a particulate filter, and/or the like. One example is known as a three way catalyst. It converts the three main pollutants in automobile exhaust: an oxidizing reaction converts carbon monoxide (CO) and unburned hydrocarbons (HC) to CO₂ and water vapor, and a reduction reaction converts oxides of nitrogen (NOx) to produce CO₂, nitrogen (N₂), and water (H₂O). Another type of catalyst is known as an oxidizing catalyst which merely preforms the oxidizing portion of the three way catalyst. One more variable restriction valves, such as backpressure valve(s), may be located in communication with the scavenging exhaust manifold 63 before and/or after emissions device to enable increases in exhaust energy delivered to the turbocharger turbine 42 at low engine speed. The exhaust subsystem 28 may also include any other suitable devices.

In select variations the EGR subsystem 30 may recirculate portions of the exhaust gases from the exhaust subsystem 28 to the induction subsystem 26 for combustion in the engine 12. In one variation, as shown, the EGR subsystem 30 may include a low pressure (LP) EGR path 80 connected to the exhaust subsystem 28 upstream of the turbocharger turbine 42 and/or exhaust components connected to the EGR subsystem 30. A pipe, tube, or hose 82 may connect the exhaust subsystem 28 upstream of the turbocharger turbine 42 and connected to the EGR subsystem 30. Cylinder 20 is a cylinder and may recirculate high and low pressure exhaust gas back to the induction subsystem 14 through blowdown and scavenging valves 24, 25.

The exhaust subsystem 30 may include numerous EGR valves as known in the art. The figures depict a system having a block EGR valve(s) 88 (which may contain multiple valves not shown) being connected by conduits 96 from scavenging exhaust manifold 63, conduit 98 from blowdown exhaust manifold 62, and conduit 94 from the exhaust subsystem 28 intake downstream of the turbine 42. The EGR valve(s) 88 may be connected to the air charge cooler 54 by one or more conduits 90. EGR valve 92 then may be connected to the induction subsystem 26 either upstream or downstream of the compressor 44 through conduit 84 or 86, respectively.

As shown in FIG. 1A, conduit 120 extends from and communicates the scavenging manifold 63 to the exhaust component 124 which may include a catalyst such as a three way catalyst 126. Conduit 122 extends from and communicates the turbine 42 to the exhaust component 124. Optional oxygen (O₂) sensors 128 may be included in the conduits 122, 120 and/or exhaust component 124 to monitor the oxygen content of the exhaust gas.

The variation shown in FIG. 1B is similar except that it may include an additional oxidation catalyst 130 in the conduit 120 to scavenging exhaust manifold 63.

The variation shown in FIG. 1C is similar to that in FIG. 1B except that it has a catalyst 140, such as a three way catalyst in conduit 122. Additional oxygen sensors 128 may be included.

In engines with a turbocharger operating at a low engine speed and high load may experience high scavenging conditions due to the fresh air from the turbocharger blowing through the cylinder during overlap. This causes the air/fuel mixture to be richer than the mixture measured (and controlled) at the inlet to the catalytic convertor. The common three way catalyst described above requires a stoichiometric air/fuel mixture at its inlet to operate at its most efficient.

Referring to FIG. 1A, the exhaust gas from both the blowdown and scavenging exhaust valves 24, 25 are directed at the catalyst 124. Exhaust gas from either the blowdown or scavenging exhaust valves 24, 25 may be recirculated through the engine to effect the stoichiometric ratio of the gases resulting in a better ratio air/fuel ratio at the catalyst.

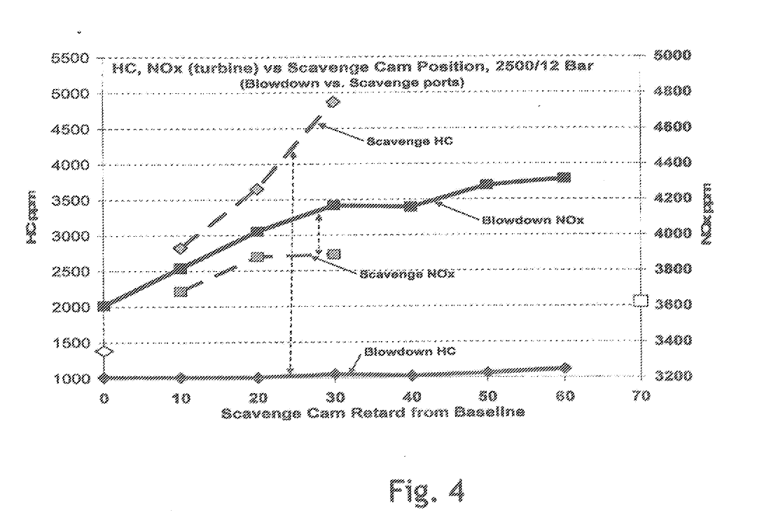

Additionally, the timing of either the blowdown or scavenging exhaust valves 24, 25 may be varied by the variable valve timing device to effect the air/fuel ratio as can be seen in FIG. 4. For one variation, as the scavenge valve is retarded, the hydrocarbon content in the scavenge exhaust manifold 63 increases. This extra hydrocarbon can be reused if the gas in recirculated in the engine. In almost all instances, the scavenge exhaust gas will contain more HC than the blowdown exhaust gas due to the timing of the blowdown and scavenging exhaust valves 24, 25 opening, which may be adjusted as necessary.

The O₂ sensors 128 may also communicate with the controller to control the EGR ratio, the air/fuel ratio, and the timing of the valves to provide an optimum result.

This variation requires less enrichment than a traditional engine if EGR is used from the scavenging valve 25 because a significant portion of the excess “scavenging” air will be returned to the engine.

The variations shown in FIGS. 1B and 1C require even less enrichment to attain a stoichiometric ratio at the catalyst 126 because of the additional oxidizing catalyst 130 in the path of the scavenging exhaust gas. The variation in FIG. 1C has an additional catalyst 140 in the path of the blowdown exhaust gas. The catalyst 140 may be an oxidizing catalyst or a three way catalyst. This takes advantage of the fact that the HC concentration in the scavenge exhaust gas is approximately four times that of the blowdown exhaust gas. Therefore some excess O₂ will be consumed in the oxidation catalyst 130 before it reaches the catalyst 126.

In select variations, the control subsystem 16 may include any suitable hardware, software, and/or firmware to carry out at least some portions of the methods disclosed herein below. For example, the control subsystem 16 may include various engine system actuators and sensors (not shown). The engine system sensors are not individually shown in the drawings but may include any suitable devices to monitor engine system parameters. For example, an engine speed sensor may measure the rotational speed of an engine crankshaft (not shown), pressure sensors in communication with the engine combustion chambers 20 may measure engine cylinder pressure, intake and exhaust manifold pressure sensors may measure pressure of gases flowing into and away from the combustion chambers 20, an inlet air mass flow sensor may measure incoming airflow in the induction subsystem 26, and an intake manifold mass flow sensor may measure flow of induction gases to the engine 12. In another variation, temperature sensors may measure the temperature of induction gases flowing to the engine 12. In a further variation, the engine system 10 may include a speed sensor suitably coupled to the turbocharger 38 to measure the rotational speed thereof. A throttle position sensor, such as an integrated angular position sensor, may measure the position of the throttle valve 56. A position sensor may be disposed in proximity to the turbocharger 38 to measure the position of VTG blades if provided. A tailpipe temperature sensor may be placed just upstream of a tailpipe outlet to measure the temperature of the exhaust gases exiting the exhaust subsystem. Also, temperature sensors may be placed upstream and downstream of the emissions device(s) to measure the temperature of exhaust gases at the inlet(s) and outlet(s) thereof. Similarly, one or more pressure sensors may be placed across the emissions device(s) to measure the pressure drop thereacross. An O₂ sensor 128 may be placed in the exhaust and/or induction subsystems to measure oxygen in the exhaust gases and/or induction gases. Finally, position sensors may measure the positions of the EGR valves.

In addition to the sensors discussed herein, any other suitable sensors and their associated parameters may be encompassed by the presently disclosed system and methods. For example, the sensors may also include accelerator sensors, vehicle speed sensors, powertrain speed sensors, filter sensors, other flow sensors, vibration sensors, knock sensors, intake and exhaust pressure sensors, and/or the like. In other words, any sensors may be used to sense any suitable physical parameters including electrical, mechanical, and chemical parameters. As used herein, the term sensor may include any suitable hardware and/or software used to sense any engine system parameter and/or various combinations of such parameters.

The control subsystem 16 may further include one or more controllers (not separately shown) in communication with the actuators and sensors for receiving and processing sensor input and transmitting actuator output signals. The controller(s) may include one or more suitable processors and memory devices (not separately shown). The memory may be configured to provide storage of data and instructions that provide at least some of the functionality of the engine system 10 and that may be executed by the processor(s). At least portions of the method may be enabled by one or more computer programs and various engine system data or instructions stored in memory as look-up tables, formulas, algorithms, maps, models, or the like. In any case, the control subsystem 16 may control engine system parameters by receiving input signals from the sensors, executing instructions or algorithms in light of sensor input signals, and transmitting suitable output signals to the various actuators. As used herein, the term “model” may include any construct that represents something using variables, such as a look up table, map, formula, algorithm and/or the like. Models may be application specific and particular to the exact design and performance specifications of any given engine system.

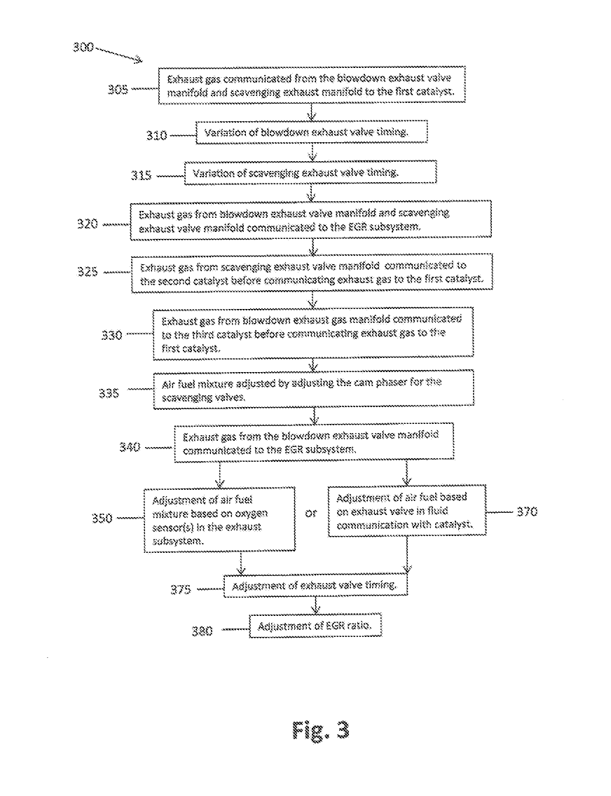

One variation of the invention may include a method which may be carried out as one or more computer programs within the operating environment of the engine system 10 described above. Those skilled in the art will also recognize that a method according to any number of variations of the invention may be carried out using other engine systems within other operating environments. Referring now to FIG. 3, a select variation may include a method 300 for exhaust aftertreatment for an internal combustion engine system which includes an engine with at least one cylinder. Each cylinder with divided exhaust gas flow between blowdown and scavenging exhaust valves. At least one cylinder is connected to an exhaust subsystem through a blowdown exhaust valve manifold and a scavenging exhaust valve manifold. The exhaust subsystem is in fluid communication with a first catalyst. As the description of this particular variation of the method 300 progresses, reference will be made to the engine system 10 of FIG. 1A-1C.

Although the term “step” is used herein, such is not intended to limit the invention to specific components, elements or acts described herein.

As shown at step 305, exhaust gas may be communicated from at the blowdown exhaust valve manifold and the scavenging exhaust valve manifold to the first catalyst.

At step 310, the timing of the blowdown exhaust valve may be varied.

At step 315, the timing of the scavenging exhaust valve may be varied.

At step 320, wherein the engine system further comprises an EGR subsystem in fluid connection with the blowdown exhaust valve manifold and the scavenging exhaust valve manifold, exhaust gas from the blowdown exhaust valve manifold and the scavenging exhaust valve manifold may be communicated to the EGR subsystem.

At step 325, wherein the exhaust subsystem includes a second catalyst between the scavenging exhaust valve manifold and the first catalyst, exhaust gas from the scavenging exhaust gas manifold may be communicated to the second catalyst before communicating exhaust gas to the first catalyst.

At step 330, wherein the exhaust subsystem includes a third catalyst between the blowdown exhaust valve manifold and the first catalyst, exhaust gas from the blowdown exhaust gas manifold may be communicated to the third catalyst before communicating exhaust gas to the first catalyst.

At step 335, the engine is provided with a cam phaser for the scavenging valves and the air fuel mixture may be adjusted by adjusting the cam phaser.

At step 340, wherein the engine system further comprises an EGR subsystem in fluid connection with the blowdown exhaust valve manifold, exhaust gas from the blowdown exhaust valve manifold may be communicated to the EGR subsystem.

At step 350, wherein the exhaust subsystem includes at least one oxygen sensor, the method further includes sensing the amount of oxygen in the exhaust subsystem and using that information to adjust the air fuel mixture.

Another method of controlling the air fuel mixture of exhaust gas entering a catalyst for an engine having at least one cylinder, the cylinder having at least one exhaust valve, wherein the exhaust valve is in fluid communication with the catalyst is depicted at 370.

At step 375, the timing of exhaust valve may be adjusted.

At step 380, wherein the engine further includes an induction system for directing air into the at least one cylinder and an EGR subsystem in fluid communication between the exhaust valve and the induction subsystem, the method may further comprise adjusting the EGR ratio.

The method 300 or 350 or any portion thereof may be performed as part of a product such as the system 10 of FIG. 1, and/or as part of a computer program that may be stored and/or executed by the control subsystem 16. The computer program may exist in a variety of forms both active and inactive. For example, the computer program may exist as software program(s) comprised of program instructions in source code, object code, executable code or other formats; firmware program(s); or hardware description language (HDL) files. Any of the above may be embodied on a computer usable medium, which include storage devices and signals, in compressed or uncompressed form. Illustrative computer usable storage devices include conventional computer system RAM (random access memory), ROM (read only memory), EPROM (erasable, programmable ROM), EEPROM (electrically erasable, programmable ROM), and magnetic or optical disks or tapes.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a method of exhaust aftertreatment for an internal combustion engine system which includes an engine with at least one cylinder, each cylinder with divided exhaust gas flow between at least one blowdown exhaust valve and at least one scavenging exhaust valve, and at least one cylinder connected to an exhaust subsystem through a blowdown exhaust valve manifold and a scavenging exhaust valve manifold having the exhaust subsystem in fluid communication with a first catalyst, the exhaust subsystem in communication with the engine wherein the method comprises communicating exhaust gas from at the blowdown exhaust valve manifold and the scavenging exhaust valve manifold to the first catalyst; and varying the timing of the blowdown exhaust valve.

Variation 2 may include the method of Variation 1 further comprising varying the timing of the at least one scavenging exhaust valve.

Variation 3 may include a method as set forth in Variation 2 wherein the engine system further comprises an EGR subsystem in fluid connection with the blowdown exhaust valve manifold and the scavenging exhaust valve manifold, the method further comprises communicating exhaust gas from the blowdown exhaust valve manifold and the scavenging exhaust valve manifold to the EGR subsystem.

Variation 4 may include a method as set forth in Variation 3 wherein the exhaust subsystem includes a second catalyst between the scavenging exhaust valve manifold and the first catalyst, the method comprises communicating exhaust gas from the scavenging exhaust gas manifold to the second catalyst before communicating exhaust gas to the first catalyst

Variation 5 may include a method as set forth in Variation 4 wherein the exhaust subsystem includes a third catalyst between the blowdown exhaust valve manifold and the first catalyst, the method comprises communicating exhaust gas from the blowdown exhaust gas manifold to the third catalyst before communicating exhaust gas to the first catalyst.

Variation 6 may include a method as set forth in Variation 5 wherein the exhaust subsystem includes a third catalyst between the blowdown exhaust valve manifold and the first catalyst, the method comprises communicating exhaust gas from the blowdown exhaust gas manifold to the third catalyst before communicating exhaust gas to the first catalyst.

Variation 7 may include a method as set forth in any of Variations 1-6 or 8-11 wherein the engine is provided with a cam phaser for the at least one scavenging exhaust valve, and the air fuel mixture may be adjusted by adjusting the cam phaser.

Variation 8 may include a method as set forth in any of Variations 1, 2 or 7 wherein the engine system further comprises an EGR subsystem in fluid connection with the blowdown exhaust valve manifold, the method further comprises communicating exhaust gas from the blowdown exhaust valve manifold to the EGR subsystem.

Variation 9 may include a method as set forth in any of Variations 1-8 and 10-11 wherein the exhaust subsystem includes at least one oxygen sensor, the method further comprises sensing the amount of oxygen in the exhaust subsystem and using that information to adjust the air fuel mixture.

Variation 10 may include a method of controlling the air fuel mixture of exhaust gas entering a catalyst for an engine having at least one cylinder, the cylinder having at least one exhaust valve, wherein the exhaust valve is in fluid communication with the catalyst, the method comprises adjusting the timing of exhaust valve.

Variation 11 may include a method as set forth in Variation 10 wherein the engine further includes an induction system for directing air into the at least one cylinder and an EGR subsystem in fluid communication between the exhaust valve and the induction subsystem, the method further comprises adjusting the EGR ratio.

Variation 12 may include an internal combustion engine system, comprising: an internal combustion engine including a plurality of cylinders, each having at least one blowdown exhaust valve and at least one scavenging exhaust valve wherein at least one cylinder is connected to an exhaust subsystem to carry exhaust gases away from the engine; wherein the exhaust subsystem carries exhaust gases away from the engine, and including a blowdown exhaust manifold in communication with the at least one blowdown exhaust valve of the cylinders connected to the exhaust subsystem, and a scavenging exhaust manifold in communication with the at least one scavenging exhaust valve of the cylinders connected to the exhaust subsystem; a first catalyst connected to the exhaust subsystem; and a controller configured and arranged to adjust the timing of the at least one scavenging exhaust valve or the at least one blowdown exhaust valve to control the air fuel mixture of the exhaust gas entering the first catalyst.

Variation 13 may include a system as set forth in Variation 12, further comprising a second catalyst between the scavenging exhaust valve manifold and the first catalyst.

Variation 14 may include a system as set forth in any of Variations 12-13 further comprising a third catalyst between the blowdown exhaust valve manifold and the first catalyst

Variation 15 may include a system as set forth in Variation 13, further comprising a third catalyst between the blowdown exhaust valve manifold and the first catalyst.

Variation 16 may include a system as set forth in any of Variations 12-15, further comprising an induction subsystem and an EGR subsystem in communication with the induction subsystem and in communication with the blowdown exhaust valve manifold and the scavenging exhaust valve manifold.

Variation 17 may include a system as set forth in Variation 16, wherein the controller also controls the EGR subsystem to control the air fuel mixture.

Variation 18 may include a system as set forth in any of Variations 12-17 further comprising a variable valve timing device to vary the timing of the at least one scavenging exhaust valve or the at least one blowdown exhaust valve.

Variation 19 may include a system as set forth in Variation 18 wherein the variable valve timing device comprises a concentric cam device to vary timing of the exhaust valves and including a cam shaft carried by a cam tube, wherein the cam shaft carries blowdown or scavenging valve cams and the cam tube carries the other of the blowdown or scavenging valve cams, and at least one cam phaser to vary a phase relationship of the cam tube and shaft with respect to an engine crankshaft.

Variation 20 may include a system as set forth in Variation 19 wherein the at least one cam phaser varies the phase relationship of the cam shaft and tube independently with respect to one another and with respect to the engine crankshaft.

Variation 21 may include a system as set forth in any of Variations 12-20, further comprising a turbocharging subsystem including a compressor operatively connected to a turbine in communication with the blowdown exhaust manifold.

Variation 22 may include an internal combustion engine system, comprising: an internal combustion engine including a plurality of cylinders, each having at least one blowdown exhaust valve and at least one scavenging exhaust valve wherein at least one cylinder is connected to an exhaust subsystem to carry exhaust gases away from the engine; wherein the exhaust subsystem carries exhaust gases away from the engine, and including a blowdown exhaust manifold in communication with the at least one blowdown exhaust valve of the cylinders connected to the exhaust subsystem, and a scavenging exhaust manifold in communication with the at least one scavenging exhaust valve of the cylinders connected to the exhaust subsystem; a first catalyst fluidly connected to the blowdown exhaust manifold

The above description of variations of the invention is merely exemplary in nature and, thus, variations thereof are not to be regarded as a departure from the spirit and scope of the invention.

What is claimed is:

1. A method of exhaust aftertreatment for an internal combustion engine system, which includes an engine with at least one cylinder, each cylinder with divided exhaust gas flow between at least one blowdown exhaust valve and at least one scavenging exhaust valve, and at least one cylinder connected to an exhaust subsystem through a blowdown exhaust valve manifold and a scavenging exhaust valve manifold having the exhaust subsystem in fluid communication with a first catalyst, the exhaust subsystem in communication with the engine, the method comprising:
communicating exhaust gas from at the blowdown exhaust valve manifold and the scavenging exhaust valve manifold to the first catalyst; and
varying the timing of the at least one blowdown exhaust valve.

2. The method of claim 1 further comprising varying the timing of the at least one scavenging exhaust valve.

3. The method of claim 2 further wherein the engine system further comprises an EGR subsystem in fluid connection with the blowdown exhaust valve manifold and the scavenging exhaust valve manifold, the method further comprising:
communicating exhaust gas from the blowdown exhaust valve manifold and the scavenging exhaust valve manifold to the EGR subsystem.

4. The method of claim 3 further wherein the exhaust subsystem includes a second catalyst between the scavenging exhaust valve manifold and the first catalyst, the method comprising communicating exhaust gas from the scavenging exhaust gas manifold to the second catalyst before communicating exhaust gas to the first catalyst.

5. The method of claim 4 wherein the exhaust subsystem includes a third catalyst between the blowdown exhaust valve manifold and the first catalyst, the method comprising communicating exhaust gas from the blowdown exhaust gas manifold to the third catalyst before communicating exhaust gas to the first catalyst.

6. The method of claim 5 wherein the exhaust subsystem includes a third catalyst between the blowdown exhaust valve manifold and the first catalyst, the method comprising communicating exhaust gas from the blowdown exhaust gas manifold to the third catalyst before communicating exhaust gas to the first catalyst.

7. The method of claim 1 wherein the engine is provided with a cam phaser for the at least one scavenging exhaust valve, and the air fuel mixture is adjusted by adjusting the cam phaser.

8. The method of claim 1 wherein the engine system further comprises an EGR subsystem in fluid connection with the blowdown exhaust valve manifold, the method further comprising:
communicating exhaust gas from the blowdown exhaust valve manifold to the EGR subsystem.

9. The method of claim 1 wherein the exhaust subsystem includes at least one oxygen sensor, the method further comprising sensing the amount of oxygen in the exhaust subsystem and using that information to adjust the air fuel mixture.

10. A method of controlling the air fuel mixture of exhaust gas entering a catalyst for an engine having at least one cylinder, the cylinder having at least one exhaust valve, wherein the exhaust valve is in fluid communication with the catalyst, the method comprising:
adjusting the timing of exhaust valve.

11. The method of claim 10 wherein the engine further includes an induction system for directing air into the at least one cylinder and an EGR subsystem in fluid communication between the exhaust valve and the induction subsystem, the method further comprising:
adjusting the EGR ratio.

12. An internal combustion engine system, comprising:
an internal combustion engine including a plurality of cylinders, each having at least one blowdown exhaust valve and at least one scavenging exhaust valve wherein at least one cylinder is connected to an exhaust subsystem to carry exhaust gases away from the engine;
wherein the exhaust subsystem carries exhaust gases away from the engine, and including a blowdown exhaust manifold in communication with the at least one blowdown exhaust valve of the cylinders connected to the exhaust subsystem, and a scavenging exhaust manifold in communication with the at least one scavenging exhaust valve of the cylinders connected to the exhaust subsystem;
a first catalyst connected to the exhaust subsystem; and
a controller configured and arranged to adjust the timing of the at least one scavenging exhaust valve or blowdown exhaust valve to control the air fuel mixture of the exhaust gas entering the first catalyst.

13. The system of claim 12, further comprising a second catalyst between the scavenging exhaust valve manifold and the first catalyst.

14. The system of claim 12 further comprising a third catalyst between the blowdown exhaust valve manifold and the first catalyst.

15. The system of claim 13, further comprising a third catalyst between the blowdown exhaust valve manifold and the first catalyst.

16. The system of claim 12, further comprising an induction subsystem and an EGR subsystem in communication with the induction subsystem and in communication with the blowdown exhaust valve manifold and the scavenging exhaust valve manifold.

17. The system of claim 16, wherein the controller also controls the EGR subsystem to control the air fuel mixture.

18. The system of claim 12 further comprising a variable valve timing device to vary the timing of the at least one scavenging exhaust valve or the at least one blowdown exhaust valve.

19. The system of claim 18 wherein the variable valve timing device comprises a concentric cam device to vary timing of the exhaust valves and including a cam shaft carried by a cam tube, wherein the cam shaft carries blowdown or scavenging valve cams and the cam tube carries the other of the blowdown or scavenging valve cams, and at least one cam phaser to vary a phase relationship of the cam tube and shaft with respect to an engine crankshaft.

20. The system of claim 19, wherein the at least one cam phaser varies the phase relationship of the cam shaft and tube independently with respect to one another and with respect to the engine crankshaft.

21. The system of claim 12 further comprising a turbocharging subsystem including a compressor operatively connected to a turbine in communication with the blowdown exhaust manifold.

22. An internal combustion engine system, comprising:
an internal combustion engine including a plurality of cylinders, each having at least one blowdown exhaust valve and at least one scavenging exhaust valve wherein at least one cylinder is connected to an exhaust subsystem to carry exhaust gases away from the engine;
wherein the exhaust subsystem carries exhaust gases away from the engine, and including a blowdown exhaust manifold in communication with the at least one blowdown exhaust valve of the cylinders connected to the exhaust subsystem, and a scavenging exhaust manifold in communication with the at least one scavenging exhaust valve of the cylinders connected to the exhaust subsystem; and
a first catalyst fluidly connected to the blowdown exhaust manifold.
